(19) United States
(12) Patent Application Publication
(10) Pub. No.: US 2021/0137091 A1
(43) Pub. Date: May 13, 2021

(54) FLY TRAP AND SYSTEM FOR CONVERTING TRAP

(71) Applicant: AP&G Co., Inc., Bayonne, NJ (US)

(72) Inventor: Edward William Dolshun, Warwick, NY (US)

(21) Appl. No.: 17/093,100

(22) Filed: Nov. 9, 2020

Related U.S. Application Data
(60) Provisional application No. 62/932,619, filed on Nov. 8, 2019.

(51) Int. Cl. A01M 1/10; A01M 1/02

(52) U.S. Cl. CPC A01M 1/106; A01M 1/02

(57) ABSTRACT

A device for converting an ovi trap commonly used to capture mosquitos into a trap configured for trapping flies. The device includes an insert having a disc-shaped member that has holes on one end and channels extending from the holes on the other end. The insert is placed on a cylindrical capture chamber of an ovi trap such that the channels extend into the hollow of the capture chamber. Fly attractant is provided in the well of the ovi trap such that flies, attracted to the bait, will enter through the holes in the insert and fly down the channels into the capture chamber. Once in the capture chamber, they are unable to fly upwardly to escape.

### RELATED APPLICATIONS

This application claims the benefit of pending U.S. Prov. Appl. 62/932,619 filed Nov. 8, 2019, the contents of which are incorporated by reference herein.

### FIELD OF THE INVENTION

The invention relates to the field of insect traps, more specifically to a convertible fly trap.

### BACKGROUND OF THE INVENTION

Various devices have been developed which seek to reduce mosquito populations by attracting and killing mosquitos or their larvae. One such device is known as an autocidal gravid ovitrap, a dual-chambered unit designed to attract female mosquitoes to standing water, which is a desirable breeding ground. In such devices, a lower basin or similar receptacle is filled with water, and an upper chamber configured to allow the ingress of mosquitoes is suspended above the water-filled lower chamber. Typically, the inner walls of the capture chamber are provided with trap paper having a layer of adhesive material. In use, mosquitoes are attracted to the standing water in the lower basin. To get close to the water, a mosquito must enter the upper chamber. Upon doing so, the mosquito will contact and stick to the adhesive layer, and thereby become trapped in the capture chamber.

A female mosquito who does not contact the adhesive layer of the capture chamber may avoid capture and survive to lay eggs. In this respect, the device is configured to allow eggs to pass from the capture chamber into the infusion chamber through a selectively penetrable screen formed of a series of pores that are sized to allow passage of mosquito eggs, but not mosquitoes. As a result, mosquitoes that may hatch in the infusion chamber remain trapped therein.

In conventional use, decaying biological matter such as hay or the like is placed into the lower basin to serve as an additional attractant of mosquitoes.

Conventional ovitraps have traditionally only been used to attract and capture mosquitoes. However, there are other nuisance insects that may also pose potential health threats, which may not be captured as effectively as mosquitoes by the conventional ovitrap.

### SUMMARY OF THE INVENTION

Embodiments of the invention are directed to a convertible ovitrap system that may be used to capture common flies.

The device is formed of a capture chamber and an infusion chamber. The invention provides a method for converting a traditional ovitrap for mosquitoes into a trap for flies. The device used to convert the trap allows flies to easily enter the capture chamber, but not escape.

The invention also provides a basin configured to hold a predetermined volume of liquid and fly bait as an attractant.

Other principal features and advantages of the invention will become apparent to those skilled in the art upon review of the following drawings and detailed description.

### BRIEF DESCRIPTION OF THE DRAWINGS

Illustrative embodiments of the invention will hereafter be described with reference to the accompanying drawings, wherein like numerals denote like elements.

FIG. 1 is a side perspective view of a fly-trap insert according to an exemplary embodiment of the invention.

FIG. 2 is an exploded view of a trap according to an exemplary embodiment of the invention.

FIG. 3 is an exploded view of a capture chamber known in the prior art for trapping mosquitoes.

FIG. 4 is a top perspective view of the placement of insert of FIG. 1 which converts the prior art capture chamber device of FIG. 3.

FIG. 5 is a cross-sectional view of the converted trap of FIG. 2 according to an exemplary embodiment of the invention.

### DETAILED DESCRIPTION OF THE INVENTION

Embodiments of the present invention will now be described with reference to the above-identified Drawings. It will be understood that various modifications of the present description are possible without departing from the spirit of the invention. Also, features described herein may be omitted, additional features may be included, and/or features described herein may be combined in a manner different from the specific combinations recited herein, all without departing from the spirit of the invention.

FIG. 1 shows a side perspective view of a circular fly-trap insert 70 according to an embodiment of the invention. In embodiments of the invention, a removable insert 70 is provided to convert a traditional mosquito ovitrap into a fly trap. Insert 70 has a disc portion with a substantially flat back face 72 with a plurality of circular holes or a similar series of openings (not shown in FIG. 1). A front face 74 of insert 70 is provided with a series of cylindrical channels 76 which emanate from the circular holes on the surface of face 74. In embodiments of the invention, the back face 72 may be colored blue, for example, as flies are more attracted to this color.

FIG. 2 shows an exploded view of a trap 10 according to an embodiment of the invention. As shown, the trap 10 is formed of at least a lower basin 12, a lid 13, and a vertical cylindrical member 32. In this embodiment, basin 12 is formed of a rounded wall 16 having an exterior surface 16a, an interior surface 16b, and an upper lip 18. At their lower ends, basin walls 16 terminate in a floor surface 20. It will be understood that basin 12 may be formed in any of various shapes, including conical, cylindrical or square in different embodiments of the invention.

In embodiments of the invention, the lower segment of basin 12 forms a well that is configured to retain a predetermined volume of liquid, such as water. Any various quantities of fly attractant may also be added to the water, thereby forming an infusion chamber 25 configured to attract flies.

In embodiments of the invention, the center of lid 13 has a circular hole 17 with a diameter such that the diameter of the walls 34 of cylinder 32 can fit within the hole 17.

In embodiments of the invention, the lid 13 is releasably secured to basin 12 during use. For example, in embodiments of the invention, lid 13 includes a circular ring 26 having a track, channel or a series of retaining barbs configured to receive and grip upper lip 18 of basin 12. As such, lid 13 may be seated on basin 12 and selectively secured thereto. It will be understood that any of various temporary securement mechanisms may be used to temporarily secure lid 13 to basin 12 in different embodiments of the invention.

In embodiments of the invention, cylinder 32 is secured to lid 13 during use. For example, in embodiments of the invention, the lid 13 includes a circular ring 15 around the circumference of hole 17 on which an outer ring 33 on walls 34 of cylinder 32 can rest and be selectively secured thereto. It will be understood that any of various temporary securement mechanisms may be used to temporarily secure cylinder 32 to lid 13 in different embodiments of the invention.

In an exemplary set up of the trap, a user initially removes the lid 13 and fills basin 12 with water. Optionally, the user may add fly attractant (e.g. fly bait) into the infusion chamber 25. The lid 13 is then placed atop of basin 12 and any securement mechanism is engaged to temporarily secure lid 13 to basin 12. Thereafter, cylinder 32 is placed within hole 17 on lid 13, and any securement mechanism is engaged to temporarily secure cylinder 32 to lid 13.

To prevent the water level in basin 12 from rising into the capture chamber 40, a drain system is provided to maintain the water in the infusion chamber 25 at a level that is below the capture chamber 40. Slits 62 are overfill drain holes that allow outflow of water from the basin 12, thereby preventing the water level in the basin 12 from rising above the level of the slits 62. The slits 62, as such, provide a safety mechanism by preventing the water level from rising into capture chamber 40. It will be understood by those of ordinary skill in the art that width of slits 62 are smaller than the size of a formed fly. Thus, in embodiments of the invention, the well segment of basin 12 is configured to retain a predetermined maximum volume of water. That is, the capacity of the infusion chamber 25 is the basin volume between the slits 62 and the floor surface 20.

FIG. 3 shows an exploded view of a capture chamber 40, which is traditionally used in prior art to trap mosquitoes. As shown, chamber 40 is comprised of a cylindrical member 32, which extends upwardly from floor surface 30. Walls 34 of cylinder 32 have an exterior surface 34a, an interior surface 34b and an upper lip 36. Upper lip 36 defines an upper opening 38. The interior area of cylinder 32 defines a capture chamber 40 through which flies enter the trap 10.

In embodiments of the invention, a removable vented lid 50 is provided to cover capture chamber 40. For example, the vented lid 50 has a circular top plate 52 and a collar 54 descending downwardly from and substantially orthogonally to top plate 52. Top plate 52 has a grill 56 (or a similar series of openings) to allow the ingress of flies into the capture chamber 40. When assembled, the vented lid 50 is seated on lip 36 of cylinder 32 such that collar 54 surrounds and contacts the outer surface 34a of cylinder 32.

In embodiments of the invention, floor surface 30 is formed with a series of openings 39, which serve as a conduit between the infusion chamber 25 and the capture chamber 40. It will be understood that when converted to a fly trap in accordance with embodiments of the invention, fly bait, such as granular fly bait sold by CATCHMASTER is added to the infusion chamber.

In use, a removable screen 42 is placed within cylinder 32 and is positioned on the floor 30. Screen 42 is sized and shaped to cover openings 39 in floor 30, while at the same time allow flies to view and sense the standing water and fly attractant in the infusion chamber 25.

As shown, in embodiments of the invention an adhesive sheet 44 is inserted into the capture chamber 40. Adhesive sheet 44 preferably has an inner surface 46 that is coated with adhesive material (e.g. glue) and an outer surface 48 that is not coated with adhesive material. The adhesive sheet is rolled and inserted into cylinder 32 such that non-coated outer surface 48 contacts inner surface 34b of cylinder 32, and inner adhesive-coated surface 46 faces inward, toward the center of the capture chamber 40.

FIG. 4 shows a top perspective view of insert 70 placed within lid 50 of capture chamber 40. In embodiments of the invention, the back face 72 of insert 70 is placed against the bottom plate of lid 50, within collar 54. In embodiments of the invention, the holes on the back face 72 (and subsequently, channels 76 on face 74) of insert 70 face upwardly so that they may be accessed by flies. In embodiments of the invention the holes are specifically positioned to be aligned with the openings of grill 56 (or similar series of openings) on lid 50. The insert 70 is, thus, placed facing downward into the cylinder 32 such that cylindrical channels 76 project downward into the capture chamber 40.

FIG. 5 shows a cross-sectional view of the fly trap according to an embodiment of the invention. When assembled, the lid 50, which holds insert 70, is seated on lip 36 of cylinder 32, and the collar 54 surrounds and contacts the outer surfaces 34a of cylinder 32. As shown, back face 72 is the upper surface of the insert in use and is substantially parallel to the underside surface of lid 50. When assembled, the cylindrical channels 76 of insert 70 extend into capture chamber 40 and terminate within hollow of the capture chamber 40. In use, flies attracted to the bait are able to enter the channels 76 of insert 70 (e.g. through the grill 56 of lid 50). The channels 76 allow flies to enter the capture chamber 40. The flies are subsequently trapped in capture chamber 40 as they are unable to fly upward and back through the narrow channels 76.

It will be understood that in embodiments of the invention, lid 50 may be omitted and insert 70 may be seated directly on cylinder 32 without any securing lid.

It will be understood that in embodiments of the invention, an adhesive sheet 44 is inserted into the capture chamber 40 with its inner surface 46 that is coated with adhesive material (e.g. glue) faces the interior of the capture chamber 40 so as to trap any flies that contact the adhesive surface.

The above invention provides a method of converting a traditional ovitrap for mosquitoes into a trap for flies. The method of reconfiguring consists of the steps of (1) adding fly bait to the infusion chamber of an ovitrap; (2) placing an insert 70 with narrow cylindrical channels 76 within lid 50 of capture chamber 40; (3) temporarily securing lid 50, which holds insert 70, to cylinder 32; and (4) temporarily securing cylinder 32 to lid 13 of trap 10.

Having described the subject matter of the application with regard to specific embodiments, it is to be understood that the description is not meant as a limitation since further modifications and variations may be apparent or may suggest themselves to those skilled in the art. It is intended that the present application cover all such modifications and variations.

What is claimed is:

1. An insert for a fly trap, comprising:
a disc-shaped member having an upper surface and an underside surface;
the disc-shaped member comprising a plurality of holes in the upper surface;
the disc-shaped member comprising a respective cylindrical members emanating from each of the plurality of holes;
the disc-shaped member sized and shaped to be seated on a cylindrical-shaped capture chamber of an ovi-trap such that respective cylindrical members terminate within a hollow portion of the capture chamber;
a lid having a grill comprising openings, the lid having an upper surface and an underside surface, whereby the lid is configured to be seated above the disc-shaped member in a manner that respective openings in grill align with one or more of the plurality of holes in the upper surface of the disc-shaped member.

2. The insert of claim 1, whereby the capture chamber comprises a capture chamber of an ovi trap.

3. The insert of claim 1, whereby the capture chamber is disposed above a basin.

4. The insert of claim 3, wherein the basin is provided with fly bait.
